(19) United States
(12) Patent Application Publication
(10) Pub. No.: US 2005/0060049 A1
(43) Pub. Date: Mar. 17, 2005

(54) Low distortion audio equalizer

(76) Inventor: Patrick N. Nelson, Seattle, WA (US)

Correspondence Address: LEE & HAYES PLLC, 421 W RIVERSIDE AVENUE SUITE 500, SPOKANE, WA, 99201, US

(21) Appl. No.: 10/659,811

(22) Filed: Sep. 11, 2003

(51) Int. Cl. G05B 13/02

(52) U.S. Cl. 700/37

(57) ABSTRACT

Briefly and not exclusively, systems, methods, and articles are described for lowering the gain of the first bands of an equalizer. The gain of the first bands of the equalizer are lowered in response to a user adjusted raised gain in the second band of the equalizer. The system includes a gain calculator to determine the lowered first band gains. In one implementation, the gain calculator is configured to determine the lowered first band gains so that the overall power represented by the equalizer audio output signal does not increased. In one implementation, the gain calculator is configured to determine the lowered first band gains so that the overall volume represented by the equalizer audio output signal increases a fraction of the increased volume caused by the raised second band gain.

### TECHNICAL FIELD

The present disclosure generally relates to an equalizer, and more particularly but not exclusively to adjusting an equalizer gain.

### BACKGROUND

Computer hosted audio players are often implemented as a component of a streaming media system, and generally include an equalizer.

An audio player equalizer allows a user to control the frequency response of a digital audio signal. A user selects the frequency response of the audio signal by individually selecting the amplitude (or gain) of a number of different frequency bands. The gain of each band is generated by a digital filter application. To control the equalizer, the user selects a desired gain for each band through a computer input device. The gain for each band is generated by an equalizer application responding to the user selected gain.

An increase in selected gain in at least one band may saturate the audio signal and thus introduce distortion into the output audio signal. Distortion may be introduced by increased power in the audio signal if the audio signal amplitude is in a non-linear region of the amplification circuitry. Distortion may also be introduced by clipping, a phenomenon in which the amplitude of the audio signal exceeds the bounds of its digital representation. Clipping adds distortion and pop to the transduced sound of the audio signal. The traditional solution to this problem is a preamplifier that lowers the power of the audio so that the equalizer cannot add enough power to cause clipping. This kind of preamplifier introduces aliasing, thus reducing the accuracy of the audio data. That is undesirable. Another traditional solution to this problem is to detect that clipping is occurring, and then to normalize the audio signal so that it represents lower power. That is also undesirable because that uses a large audio buffer to detect clipping over time, and has a latency (or response time) in detecting the distorted audio signal, thus introducing inaccuracy into the output audio signal.

### SUMMARY

Briefly and not exclusively, systems, methods, and articles are described for lowering the gain of the first bands of an equalizer. The gain of the first bands of the equalizer are lowered in response to a user adjusted raised gain in the second band of the equalizer. The system includes a gain calculator to determine the lowered first band gains. In one implementation, the gain calculator is configured to determine the lowered first band gains so that the overall power represented by the equalizer audio output signal does not increase. In one implementation, the gain calculator is configured to determine the lowered first band gains so that the overall volume represented by the equalizer audio output signal increases a fraction of the increased volume caused by the raised second band gain.

In one exemplary implementation, one or more computer readable media store instructions that, when executed by at least one processor, cause the processor to perform acts that include computing a lower gain for at least one band of a multi-band equalizer in response to a user input to raise gain in one other band of the equalizer.

### BRIEF DESCRIPTION OF THE DRAWINGS

The detailed description is described with reference to the accompanying figures.

FIG. 1 is a schematic of an exemplary embodiment of an audio system having a gain calculator to calculate equalizer gain settings.

FIG. 2 is a schematic of an exemplary audio system implemented on a computer system.

FIG. 3 is a schematic of an exemplary embodiment of an audio system having a gain calculator to calculate equalizer gain setting.

FIG. 4 is a schematic of an exemplary embodiment of an audio system having a gain calculator to calculate equalizer gain setting wherein an exemplary gain calculator algorithm is portrayed.

FIG. 5 is a schematic of an exemplary embodiment of an audio system having a gain calculator to calculate equalizer gain setting wherein an exemplary gain calculator algorithm is portrayed.

FIG. 6 is a flowchart of an exemplary method of calculating the gains of an equalizer.

### DETAILED DESCRIPTION

A structure and a method to adjust the gain settings of a computer implemented multi-band graphic equalizer are described. In this description, reference is made to the accompanying drawings which form a part hereof, and in which is shown, by way of illustration, specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

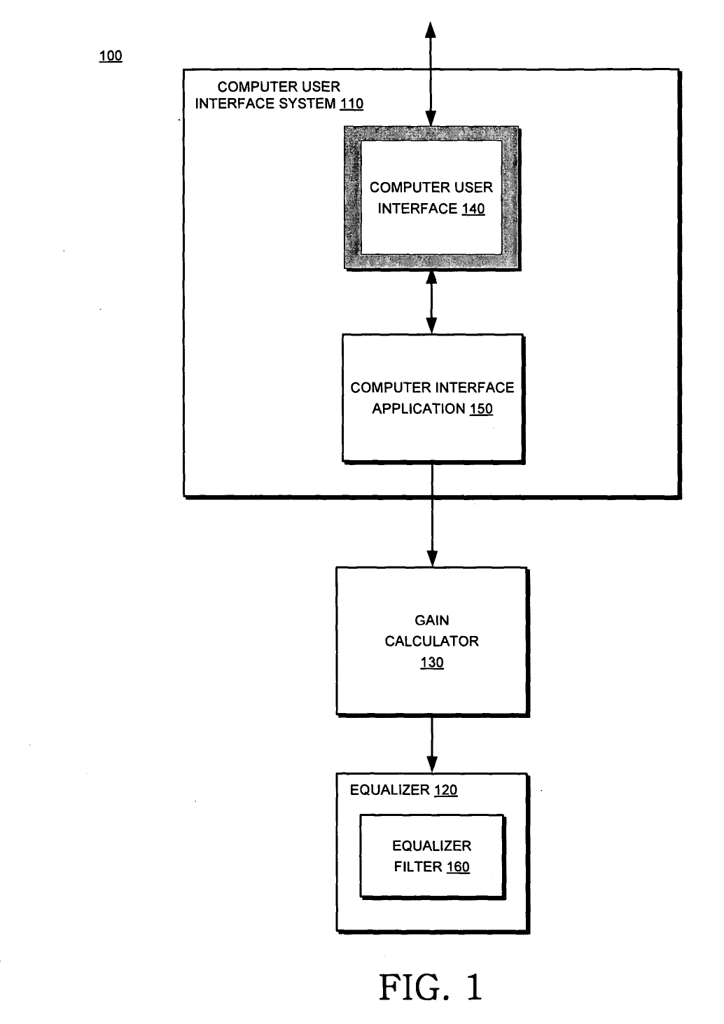

FIG. 1 shows a pictorial representation of a computer hosted audio system 100. The audio system 100 includes a computer user interface system 110 to provide for each band of an equalizer 120 a user selected gain setting to a gain calculator application 130.

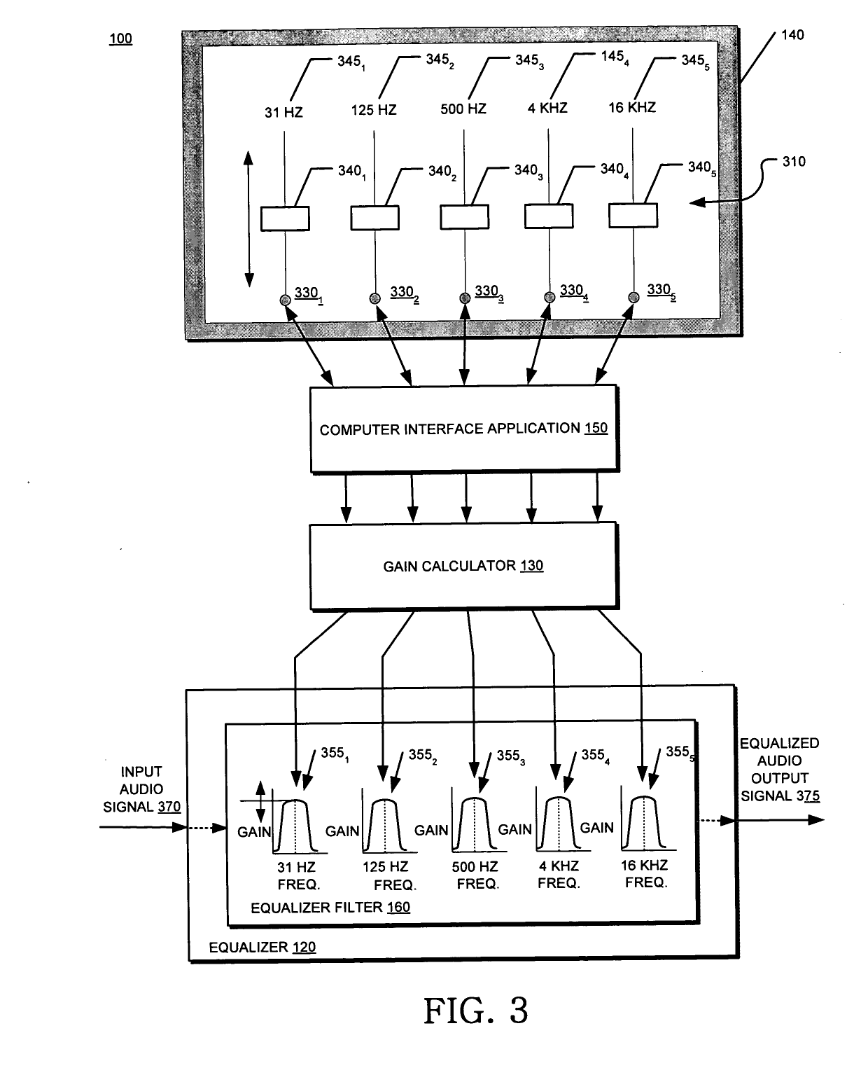

The computer user interface system 110 comprises a computer user interface 140 and a computer interface application 150. The computer interface 140 provides a man-machine interface so that a user may input user selected gain 18 settings (or changes in gain settings) for each band of the multi-band equalizer 110. The computer interface 140 is illustratively portrayed here as a computer monitor. The computer monitor is configured to display a structure for user selection of gain (or change in gain) for each band of the equalizer 110. One implementation of the computer interface 140 is as a structure comprising multiple simulated slider controls displayed on a computer monitor, each slider control for selecting a separate frequency band of the multi-band equalizer. This implementation is described presently with reference to FIG. 3. It is understood that any user interface, and any structure of the user interface, providing a structure to input a user prescribed gain setting/gain change is within the scope of the present invention. In implementations, exemplary user interfaces may illustratively include a mechanical slide control, a mechanical rotating knob, a simulated slide control displayed on a monitor as illustratively portrayed in FIG. 3, a simulated rotating knob control displayed on a monitor, and a window(s) displayed on a monitor to input a user selected gain/change by a menu selection structure or by a character input via a keyboard like device.

The computer interface application 150 is implemented as a routine stored on a media that in operation is executed by the computer. The computer interface application 150 is configured to drive the computer interface 140, to receive from the computer interface 140 the user provided equalizer gain or change in gain settings, and to provide the user selected gain settings, or change in gain settings, to the gain calculator application 130.

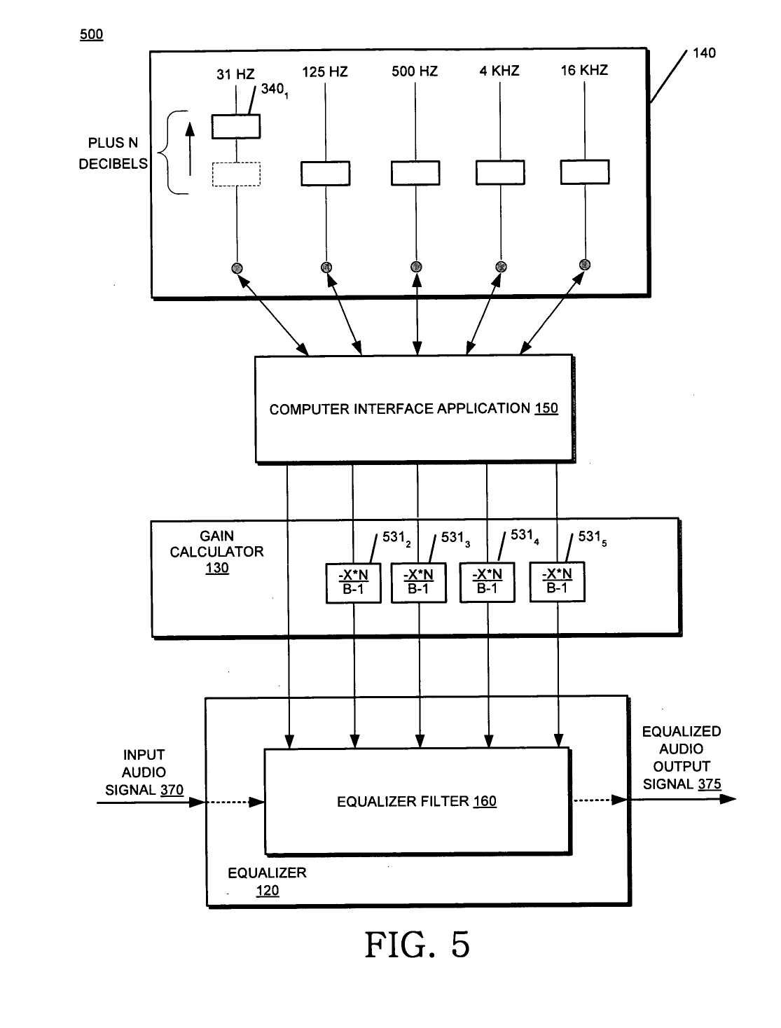

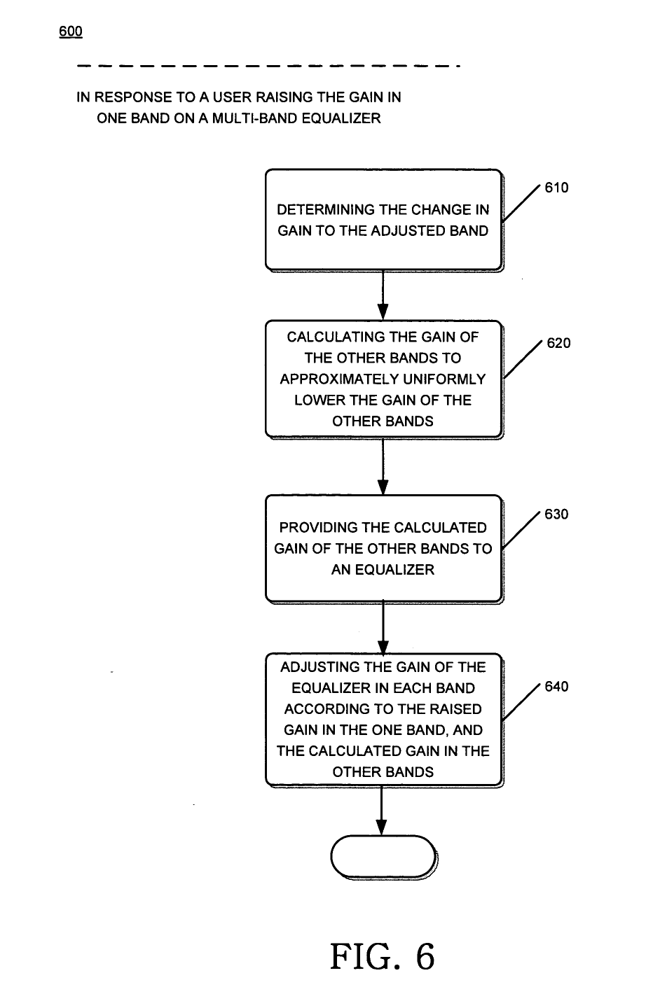

The gain calculator application 130 is implemented as a routine stored on a media that in operation is executed by the computer. The gain calculator application 130 calculates (or computes) the computer user interface system 110 provided gain settings/changes to adjust the settings so that the audio signal will not be distorted. In one implementation, the gain calculator application 130, in response to a user selected increase in one band of the equalizer, calculates a lower gain in each of the other bands of the equalizer, so that the equalizer audio output signal is not distorted. In one implementation, the gain calculator application 130, in response to the user selected increase in one band of the equalizer, calculates a lower gain in each of the other bands of the equalizer so that the overall power (or amplitude) of the audio signal does not increase, or increases a fraction of what would otherwise be the gain in power. The gain calculator application 130 provides these calculated values to the equalizer application 120. The gain calculator application 130 is further described with reference to FIGS. 5 and 6. In one implementation, the gain calculator application 130 provides the prescribed gains to the equalizer application 120 via an application program interface (API).

The equalizer application 120 is implemented as a routine stored on a media that in operation is executed by the computer. The equalizer application 120 comprises an equalizer filter application 160. The equalizer filter application 160 is implemented as a routine stored on a media that in operation is executed by the computer. The equalizer filter application 160 comprises a digital band pass filter implemented by a programmed computer. Illustrative implementations of a digital filter include an infinite impulse response filter, such as a Butterworth filter, a Bessel filter, and a Chebyshev filter; and a finite-impulse response filter such as a raised cosine filter. Each filter of the equalizer filter application 160 may be is embodied as a separate routine for each frequency band, or as a common routine for multiple frequency bands. The equalizer application 120 receives the gain calculator application 130 provided band pass filter gain setting/change, and provides these settings to the equalizer filter application 160. In one implementation, the equalizer application is configured to generate filter coefficients as prescribed by a particular filter type, to operate each filter of the filter application 160. Each filter of the equalizer filter application 160 is applied to the input audio signal to produce an equalized output audio signal. The filters 355ᵢ are applied to an input audio output signal 370 to produce the equalized audio signal 375. In one implementation, the filter coefficients are provided by the gain calculator application 130 rather than being generated by the equalizer application 120. In one implementation, the equalizer application 120 is a plug-in. In one implementation, the equalizer filter application 160 is a plug-in. In one implementation, the computer interface application 150 provides the prescribed gains to the equalizer application 120 via an API. The equalizer filter application 160 is further described with reference to FIG. 3.

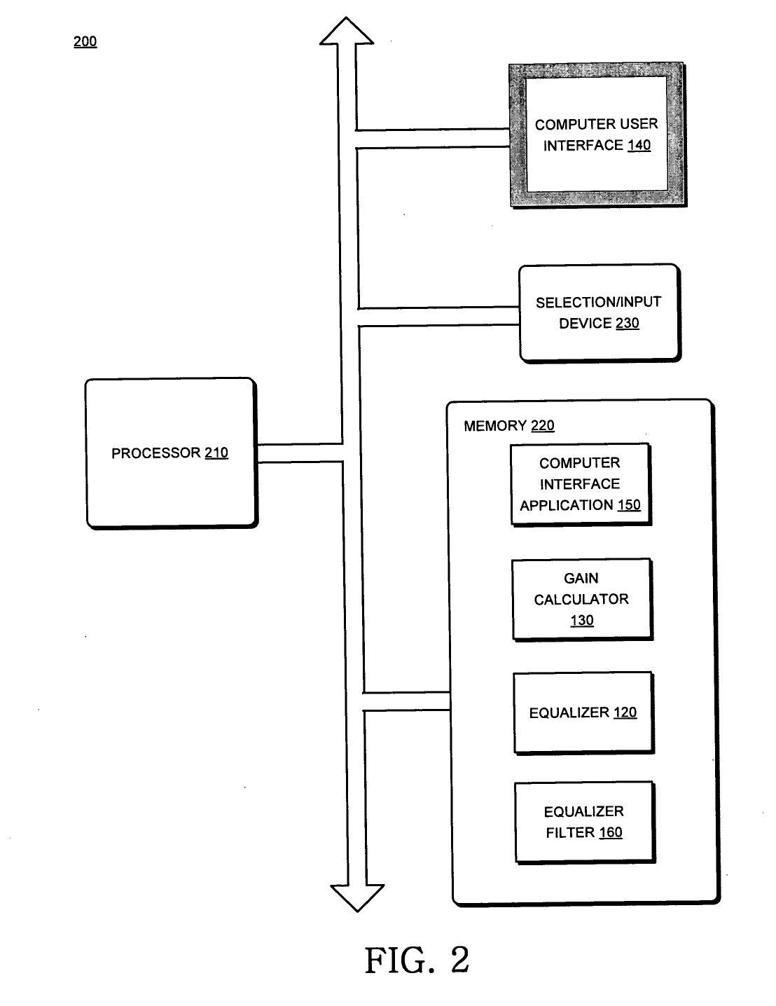

FIG. 2 shows some components of an exemplary audio system implemented on a computer system 200. The computer system 200 includes an at least one processor 210 and a coupled memory 220. In one implementation, the processor 210 is a general purpose processor. In one implementation, the processor 210 is a processor is a processor of a general purpose computer (PC), or a digital audio player such as a Windows Media® (a trademark of the Microsoft Corporation) Audio (WMA) player or an MP3 audio player. The computer system 200 is configured to process audio data from illustratively an input device such as a CD player coupled to the computer system 200, the memory 220, or a network interface for downloading data form a network (not shown). The memory 220 stores the instructions of the computer interface application 150, the gain calculator application 130, the equalizer application 120, and the equalizer filter application 160, each described with reference to FIG. 1. The computer interface application 150, the gain calculator application 130, the equalizer application 120, and the equalizer filter application 160 comprise instructions to be executed by the processor 210 in operation of the audio system. The computer system 200 further includes a coupled computer user interface 140 as illustratively described with reference to FIG. 1. The computer user interface 140 is a device for a user to select equalizer gain settings/changes, and to provide those gain settings/changes to the computer interface application 150 as described with reference to FIG. 1. The computer system 200 further includes a selection/input device 230 for a user to input data and/or select data from the computer user interface 140. Illustrative selection/input devices 230 include a keyboard, a mouse, and/or a touchpad with selection buttons.

FIG. 3 shows one implementation of the audio system 100. The audio system 100 comprises an illustrative computer user interface 140. The computer user interface 140 is a computer monitor configured to display a structure 310 for a user to select equalizer gain settings/changes. The structure 310 illustratively comprises exemplary band controls 330i, portrayed as 5 separate band controls 330₁, 330₃, 330₃, 330₄, and 330₅. Each band control 330ᵢ is illustratively portrayed as a simulated slider control 340ᵢ for an exemplary frequency band 345ᵢ.

As portrayed, the band adjustment 330₁ comprises a slider control 340ᵢ for the exemplary frequency band 31 HZ 345₁. Similarly, the band adjustment 330₂ comprises a slider control 340₂ for the exemplary frequency band 125 HZ 345₂, the band adjustment 330₃ comprises a slider control 340₃ for the exemplary frequency band 500 HZ 345₃, the band adjustment 330₄ comprises a slider control 340₄ for the exemplary frequency band 4 KHZ 345₄, and the band adjustment 330₅ comprises a slider control 340₅ for the exemplary frequency band 16 KHZ 345₅. It is understood that any user interface 100, and any structure 120 of the user interface 100, that provides a structure to input a user prescribed gain setting/gain change is within the scope of the present invention.

The output of the computer user interface 140 is provided to the operationally coupled computer interface application 150 which in turn provides the user selected gain settings/changes to the operationally coupled gain calculator application 130. The gain calculator application 130 calculates (or computes) computer interface application 150 provided gains, and provides in one implementation the gain for each band 345ᵢ to the operationally coupled equalizer application 120, for a band pass filter 355ᵢ of the equalizer filter application 160. Each band 345i is therefore operationally coupled to a filter 355ᵢ through the gain calculator application 130. In one implementation, as described with reference to FIG. 1, the gain calculator application provides the filter coefficients for each band 345ᵢ to the equalizer application 120, for a band pass filter 355ᵢ. The filters 355ᵢ are applied to an input audio output signal 370 to produce the equalized audio output signal 375. In one implementation, the equalizer 120 is a plug-in. In one implementation, the equalizer band filter 160 is a plug-in.

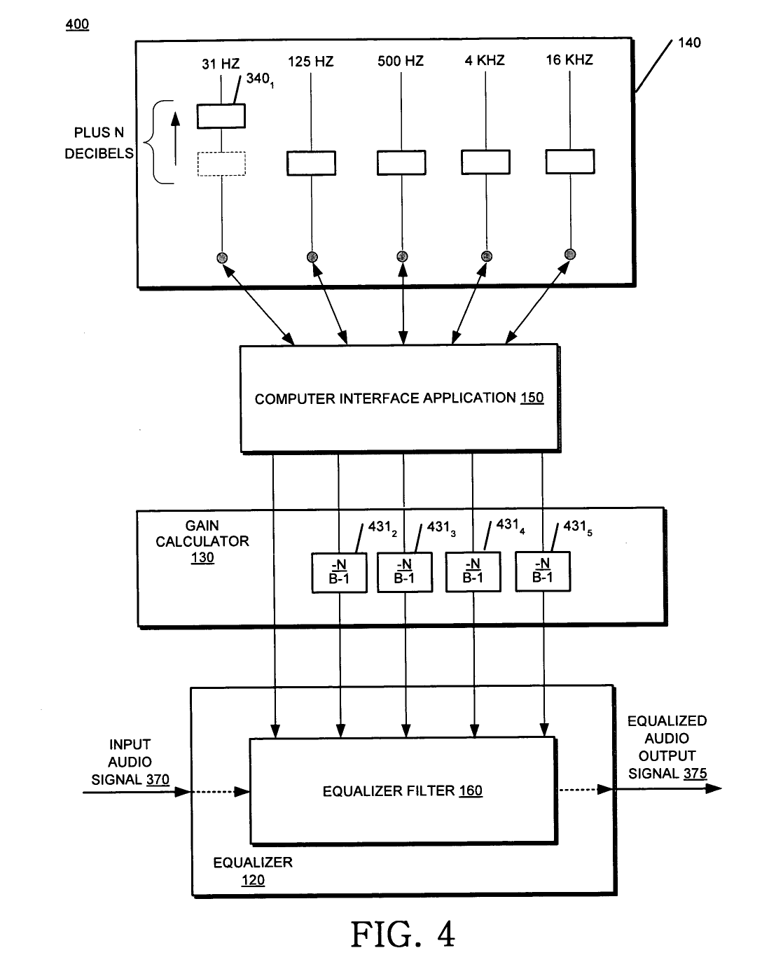

FIG. 4 shows one implementation of an audio system 400 in which the gain calculator application 130 is implemented by an algorithm described presently. The illustrative audio system 400 has the user interface 140, including the display structure 310, as described with reference to FIGS. 1 and 3. If a user raises the gain in one band of a multi-band equalizer having “B” bands, the gain calculator application 130 is configured to respond to the raised gain in the one band, by algorithmically lowering the gain in each of the other B−1 bands such that the power of the equalized audio output signal 375 is substantially the same as the power of the input audio signal 370. To the user, the band that was raised takes on the same relative prominence in the audio as with a normal equalizer, but the audio is not louder (more powerful) overall. Illustratively, the display structure 310 portrays the result of a user raising the gain of the 31 HZ band by “N” (such as “N” decibels) as a result of translating the slider control 340, upward to the “plus N” decibel position. The gain calculator application 130 is configured according to its program instructions to algorithmically adjust the gain of the illustrative other B−1 bands of the equalizer 120 by subtracting, for each of these other B−1 bands, a gain of substantially N/(B−1) 431₂ 431₃ 431₄ 431₅ from what would otherwise be the gain. By reducing the gain in each of the other “B”−1 bands by N/(B−1), the power of the equalized audio output signal 375 is substantially the same as the power of the input audio signal 370 while maintaining the selected gain increase in the selected 31 HZ band. The calculated gains of the gain calculator application 130 are provided to the equalizer application 120 and equalizer filter application 160, as described with reference to FIGS. 1 and 3. In one implementation, the gain of the other B−1 bands is reduced geometrically. In one implementation, the gain of at least one of the other B−1 bands is not calculated. In one implementation, the gains of each of the bands being calculated are not adjusted equally.

FIG. 5 shows one implementation of an audio system 500 in which the gain calculator application 130 is implemented by an algorithm described presently. The illustrative audio system 500 has the user interface 140, including the display structure 310, as described with reference to FIGS. 1 and 3. If a user raises the selected gain in one band of a multi-band equalizer having “B” bands, the gain calculator application 130 is configured to respond to the raised gain in this one band by algorithmically lowering the gain in each of the other B−1 bands, such that the power of the equalized audio output signal 375 is raised. Rather than maintaining the loudness of the audio (as described above with reference to FIG. 4), some power is added to the equalized audio output signal 375 to provide to the user with a sensation of increased power in the equalized audio output signal 375 upon the positive gain adjustment in one band. This adding of power in the equalized audio output signal 375 may introduce some distortion to the equalized audio output signal 375, but less distortion than if the gain were not reduced in the other B−1 bands. The inventor understands that raising the gain by approximately 20% in each of the other bands does not unduly distort the equalized audio output signal 375, while it does provide a listener with an adequate sensation of a raised overall audio level.

Illustratively, the display structure 310 portrays the result of a user raising the gain of the 31 HZ band by “N” (such as “N” decibels) as a result of translating the slider control 340₁ upward to the “plus N” position. The gain calculator application 130 is configured according to its program instructions to io algorithmically adjust the gain of the illustrative other B−1 bands of the equalizer 120 by subtracting, for each of the other B−1 bands, a gain of substantially (X*N)/(B−1) 531₂ 531₃ 531₄ 531₅ from what would otherwise be the gain (where X represents the fraction of N/(B−1) that is being subtracted from the gain, and “*” represents a multiplication operation). By reducing the gain in each of the other B−1 bands by a fraction “X” of N/(B−1), the power of the equalized audio output signal 375 is reduced in each band, but increased overall. The inventor understands that an “X” valued at 80% results in an adequately perceptible increase in power while at the same time helping to reduce overall distortion and not unduly distorting the equalized audio output signal 375. The calculated gains of the gain calculator application 130 are provided to the equalizer application 120 and equalizer filter application 160 as described with reference to FIGS. 1 and 3. In one implementation, the gain of the other B−1 bands is reduced geometrically. In one implementation, the gain of at least one of the other B−1 bands is not calculated. In one implementation, the gains of each of the bands being calculated are not adjusted equally.

FIG. 6 shows an exemplary method 600 to determine the gain in each of the bands of a multi-band equalizer. In one implementation, at least one computer includes stored instructions that when executed by the computer(s) (or processor(s) of the computer(s)), cause the computer(s) to execute the method 600. Referring now to FIG. 6, in response to a user raising a gain in one band of a multi-band equalizer, operation 610 determines a change in gain (or power or volume represented by the equalizer audio output signal) in the raised band. Operation 620 calculates (or computes) the gain of the bands of the equalizer that were not raised so as to lower the overall power (or volume) represented by the output audio signal of the equalizer.

In one illustrative implementation of operation 620, the gain (or power or volume) of each of the bands that was not raised are calculated to be approximately uniformly lower such that the absolute value of the total gain (or power or volume represented by the equalizer audio output signal) of the bands that were not raised are lowered by the absolute value of the gain (or power or volume represented by the equalizer audio output signal) of the band that was raised. This implementation is expressed in mathematical notation, by calculating the gain (or power or volume) of each band that was not raised by subtracting N/(B−1) from each of the other bands, where “N” represents the amount of gain (or power or volume) that the one band is raised, and “B” represents the total number of bands in the equalizer.

In one illustrative implementation of operation 620, the gain (or power or volume) of each of the bands that was not adjusted are calculated to be approximately uniformly lower such that the absolute value of the total gain of the bands that were not raised are lowered by a fraction of the absolute value of the gain (or power or volume represented by the equalizer audio output signal) of the band that was raised. This implementation is expressed in mathematical notation, by calculating the gain (or power or volume) of each band that was not raised by subtracting (X*N)/(B−1) from each of the other bands, where “N” represents the amount of gain (or power or volume) that the one band is raised, “X” represents the fraction of the absolute value of the gain (or power or volume) of the band that was raised, “*” represents the multiplication function, and “B” represents the total number of bands in the equalizer. The inventor understands that an “X” valued at 80% results in an adequately perceptible increase in power while at the same time limiting helping to reduce overall distortion and not unduly distorting the equalized audio output signal. In one illustrative implementation, the gain of the other B−1 bands is reduced geometrically. In one illustrative implementation, the gain of at least one of the other B−1 bands is not calculated. In one illustrative implementation, the gains of each of the bands being calculated are not adjusted equally.

Operation 630 provides the calculated gain of the other bands to an equalizer. Operation 640 adjusts the gain of the equalizer in each band according to the raised gain in the one band, and the calculated gain in the other bands.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. One or more computer readable media having stored thereon a plurality of instructions that, when executed by at least one processor, cause the processor to perform acts comprising:
in response to a user input to raise gain in one band of a multi-band computer implemented equalizer, computing a lower gain for at least one other band of the equalizer.

2. The media recited in claim 1 wherein said acts further comprise implementing said lower gain for the at least one other band of the equalizer in the equalizer.

3. The media recited in claim 1 wherein said computing a lower gain comprises computing a lower gain for each of the other bands of the equalizer.

4. The media recited in claim 3 wherein said computing a lower gain for each of the other bands of the equalizer comprises computing a lower gain approximately uniformly for each of the other bands of the equalizer.

5. The media recited in claim 1 wherein said computing a lower gain for at least one other band of the equalizer comprises approximately uniformly lowering the gain in the other bands of the equalizer by approximately cumulatively the value of the raised gain in the one band.

6. The media recited in claim 1 wherein said computing a lower gain for at least one other band of the equalizer comprises approximately uniformly lowering the gain in the other bands of the equalizer by approximately cumulatively a fraction of the value of the raised gain in the one band.

7. A computer system comprising:
a memory;
a processor operatively coupled to the memory; and
a routine stored in the memory that when executed by any of the processors causes the processor to perform actions including computing a lower gain for at least one first band of a multi-band equalizer in response to a user input to raise gain in a second band of the equalizer.

8. The computer system recited in claim 7 wherein said actions further comprise implementing said lower gain for the at least one first band of the equalizer.

9. The computer system recited in claim 7 wherein said computing a lower gain comprises computing a lower gain for each of the first bands of the equalizer.

10. The computer system recited in claim 9 wherein said computing a lower gain for each of the first bands of the equalizer comprises computing the lower gain approximately uniformly for each of the first bands of the equalizer.

11. The computer system recited in claim 7 wherein said computing a lower gain for at least one first band comprises approximately uniformly lowering the gain in the first bands by approximately cumulatively the value of the raised gain in the second band.

12. The computer system recited in claim 7 wherein said computing a lower gain for at least one first band comprises approximately uniformly lowering the gain in the other bands of the equalizer by approximately cumulatively a fraction of the value of the raised gain in the one band.

13. A method comprising:
in response to raising a gain in one band of a multi-band equalizer, calculating an approximately uniform lower gain in the other bands of the equalizer.

14. The method recited in claim 13 further comprising providing the calculated gain of the other bands to the equalizer.

15. The method recited in claim 13 further comprising adjusting the gain of the equalizer in each band according to the raised gain in the one band, and the calculated gain in the other bands.

16. The method recited in claim 13 wherein the calculating an approximately uniform lower gain in the other bands comprises approximately uniformly lowering the gain in the other bands by approximately cumulatively the value of the raised gain in the one band.

17. The method recited in claim 13 wherein the calculating an approximately uniform lower gain in the other bands comprises approximately uniformly lowering the gain in the other bands by approximately cumulatively a fraction of the value of the raised gain in the one band.

18. An audio system comprising:
first means for determining a lower gain for at least one first band of a multi-band equalizer in response to a user input to raise gain in a second band of the equalizer; and
second means for providing a user input to raise gain in a second band of the equalizer to said first means.

19. The audio system recited in claim 18 wherein said determining comprises determining the lower gain such that a lowering of gain in the first bands is approximately uniform for each of the first bands.

20. The audio system recited in claim 18 wherein said determining comprises determining the lower gain in the first bands such that a cumulatively lower gain in the first bands is approximately the value of the raised gain in the second band.

21. The audio system recited in claim 18 wherein said determining comprises determining the lower gain in the first bands such that a cumulatively lower gain in the first bands is approximately a fraction of the value of the raised gain in the second band.

22. The audio system recited in claim 18 further comprising:
means for providing the calculated gain in the first bands to the equalizer.

23. The audio system recited in claim 18 further comprising:
means for adjusting the gain of the equalizer in each band according to the raised gain in the second band, and the lowered gain in the first bands.

24. A computer system comprising the audio system recited in claim 18.
